(19) United States
(12) Patent Application Publication
(10) Pub. No.: US 2026/0023702 A1
(43) Pub. Date: Jan. 22, 2026

(54) Programmable DMA Architecture for QOS Support

(71) Applicant: Altera Corporation, San Jose, CA (US)

(72) Inventors: Krishna Kumar Simmadhari Ramadass, Bangalore (IN); Markos Papadonikolakis, London (GB)

(21) Appl. No.: 19/342,075

(22) Filed: Sep. 26, 2025

(51) Int. Cl. G06F 13/28

(52) U.S. Cl. CPC G06F 13/28; G06F 2213/28

(57) ABSTRACT

Systems or methods of the present disclosure may provide an integrated circuit system that includes a host comprising multiple Ethernet channels and a programmable logic device including a programmable logic fabric coupled to the multiple Ethernet channels. The programmable logic device is configured to dynamically associate a direct memory access (DMA) engine of the programmable logic fabric to an Ethernet channel of the multiple Ethernet channels during runtime of the programmable logic device without bringing the programmable logic device or other Ethernet channels down. The programmable logic device is also configured to store routing information configuration details in tables of a quality of service (QOS) arbiter and provide QOS services, via the QOS arbiter of the programmable logic device, for packets that use the dynamically associated DMA engine.

### BACKGROUND

The present disclosure relates generally to integrated circuits, such as field-programmable gate arrays and/or programmable logic devices. More particularly, the present disclosure relates to a programmable network interface controller (NIC).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Programmable logic devices may be designed and/or programmed to perform a wide variety of operations depending on user designs. For instance, programmable logic devices may be used to implement programmable NICs. Conventional NICs support multiple queues per NIC port which provide quality of service (QOS) functionalities. The number of NIC ports and number of direct memory access (DMA) queues per port are conventionally fixed. Further, when the NIC port supports break out ports, the number of DMAs per port are also fixed. Moreover, the resources that are used for the DMAs are also commonly fixed. The configuration is fixed and the QOS functionality that can be provided is also fixed.

When service providers dynamically assign ports to different customers, the number of DMAs/queues and the type of QOS services provided typically remain the same as what the ASIC or the design provides. The service provider cannot configure the new port according to the requirements of a particular end user or customer. If the ASIC provided 2 DMAs per port, the service provider would provide the same to the end user. In conventional NICs, the service provider cannot modify the design to suit particular requirements of particular end users. The service provider instead may add new hardware downstream of the NIC to create the QOS enhancements for any new customers/end users. In other words, with a conventional NIC, enabling and addressing the specific QOS demands of a new end user necessitates redesigning and providing new hardware. Furthermore, the upstream data that is handled upstream of the QOS implementation at the NIC may still suffer from head-of-line blocking (HOL) due to the traffic being handled in a single channel at the NIC. To avoid such upstream bottlenecking, such networks may demand under-provisioning of resources to ensure that QOS can be handled downstream.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit system, in accordance with an embodiment of the present disclosure;

FIG. 2 is a block diagram of an example integrated circuit system of FIG. 1, in accordance with an embodiment of the present disclosure;

FIG. 3 is a block diagram of a system with a host and a programmable logic device of a hardware networking device, in accordance with an embodiment of the present disclosure;

FIG. 4 is a block diagram of a system with a host and a programmable logic device of a hardware networking device with a dynamically generated DMA using a partial reconfiguration, in accordance with an embodiment of the present disclosure;

FIG. 5 is a flow diagram of a process for generating and assigning the DMA of FIG. 4, in accordance with an embodiment of the present disclosure;

FIG. 6 is a block diagram of a system with a host and a programmable logic device of a hardware networking device with a dynamically generated DMA using DMA pooling, in accordance with an embodiment of the present disclosure;

FIG. 7 is a flow diagram of a process for assigning the DMA of FIG. 6, in accordance with an embodiment of the present disclosure;

FIG. 8 is a block diagram of a system with break-out ports each allocated to a DMA, in accordance with an embodiment of the present disclosure;

FIG. 9 is a block diagram of the system of FIG. 8 with the break-out ports aggregated into a single port, in accordance with an embodiment of the present disclosure; and

FIG. 10 is a block diagram of a data processing system including the integrated circuit system of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As previously noted, static configuration of network ports with respect to hardware queues and DMAs creates problems with QOS and/or dynamic assignment of DMA issues. In such situations, service providers may dynamically assign new ports to customers, but the port services cannot be changed from what is provided by the network hardware. For instance, the service provider may not dynamically decide how many DMAs are to be available per port. For example, the service provider may be unable to meet needs if a customer needs more queues for a network port carrying higher priority traffic so that QOS can be enabled over other ports carrying lower priority traffic flows as flexibility is limited to network switch static capabilities.

Instead of static assignment, programmable DMA configuration enables the service provider to dynamically change the QOS features of a particular port during runtime by enabling dynamic assignment of new DMA channels by programming partial reconfiguration regions to an Ethernet port without bringing the Ethernet port down, bringing other Ethernet ports down, and/or bringing the FPGA down. This enables customers to provide different QOS features for different packet flows and/or at different times without downtime. Programmable DMA configuration may also enable flexible assignment of different DMA channels to different ports across breakout ports according to customer/end user demands. Programmable DMA configuration may further include reassigning DMA channels from Ethernet ports if the Ethernet ports do not require different packet flows. Furthermore, the programmable DMA configuration on programmable hardware enables programmable hardware priorities to different DMA channels to support QOS functionality.

As such, programmable DMA provides flexibility to the network service provider when creating networks that use QOS functionality for different packet flows. Also, when associating network ports to different customers, the service provider can choose the type of QOS to be used by the customer and provide better services. When a customer does not use that many flows, the service provide may choose to assign the DMAs to other ports or remove it from the programmable logic design during runtime without taking the programmable logic device down.

Furthermore, programmable DMA enabling hardware-based DMA provides a full-stack QOS solution to HOL blocking. Because the DMAs can be assigned and prioritized per port, any high priority traffic to the high priority DMA cannot be blocked due to low priority packets blocking a port due to downstream QOS management. Each of the DMAs can have individual interrupts and can be prioritized. The host can individually handle packets from the high priority queue and send them up the stack for processing before looking at the lower priority packets and also move them to different processors (e.g., CPUs) to ensure efficient handling.

Similarly, programmable DMA also provides a way to manage and handle buffer resources to individual DMAs as required by the user. If a particular user flow uses less bandwidth, the DMAs can be instantiated with fewer buffers while a user flow using more bandwidth can have a DMA with more buffering resources. This can be configured during runtime and help the customer change the data flow patterns on their networks.

Programmable DMA also benefits dynamic design systems that support virtual systems. When a new virtual operating system (OS) is dynamically created on CPUs, new DMAs in the programmable NIC can be associated with Ethernet ports associated with the new virtual OS.

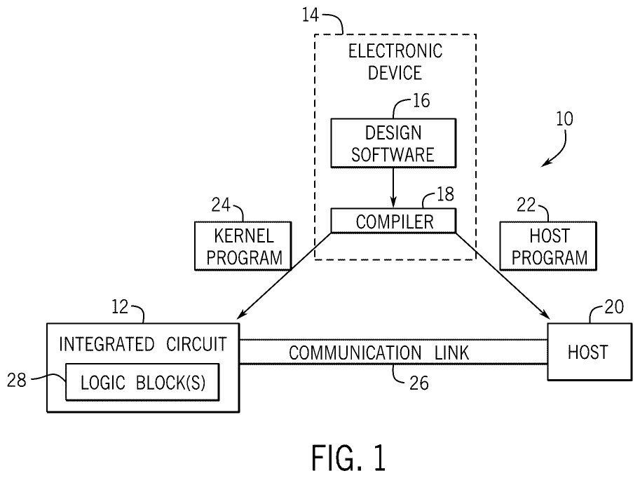

With the foregoing in mind, FIG. 1 illustrates a block diagram of a system 10 that may implement one or more designs on an integrated circuit system 12 (e.g., a single monolithic integrated circuit or a multi-die system of integrated circuits) to perform a wide variety of operations. The integrated circuit system 12 may include a single integrated circuit, multiple integrated circuits in a package, or multiple integrated circuits in multiple packages communicating remotely (e.g., via wires or traces). In some cases, the designer (e.g., user) may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve in comparison to designers that are unfamiliar with low-level hardware description languages to implement new functionalities in the integrated circuit system 12.

The integrated circuit system 12 may include a field-programmable gate array (FPGA) (e.g., Agilex™, Stratix®, Arria®, MAX®, or Cyclone® devices by Altera® Corporation). In a configuration mode of the integrated circuit system 12, a designer may use an electronic device 14 (e.g., a computer) to implement high-level designs (e.g., a system user design) using design software 16, such as a version of Quartus Design Suite® by Altera Corporation. The electronic device 14 may use the design software 16 and a compiler 18 to convert the high-level program into a lower-level description (e.g., a configuration program, a bitstream). The compiler 18 may provide machine-readable instructions representative of the high-level program to a host 20 and the integrated circuit system 12. The design software 16 may include a design tool that generates graphical user interfaces (GUIs) with different views of a design that may be implemented onto the FPGA, for example. The design tool may also provide design context and/or trade-off information associated with the design, as further described herein.

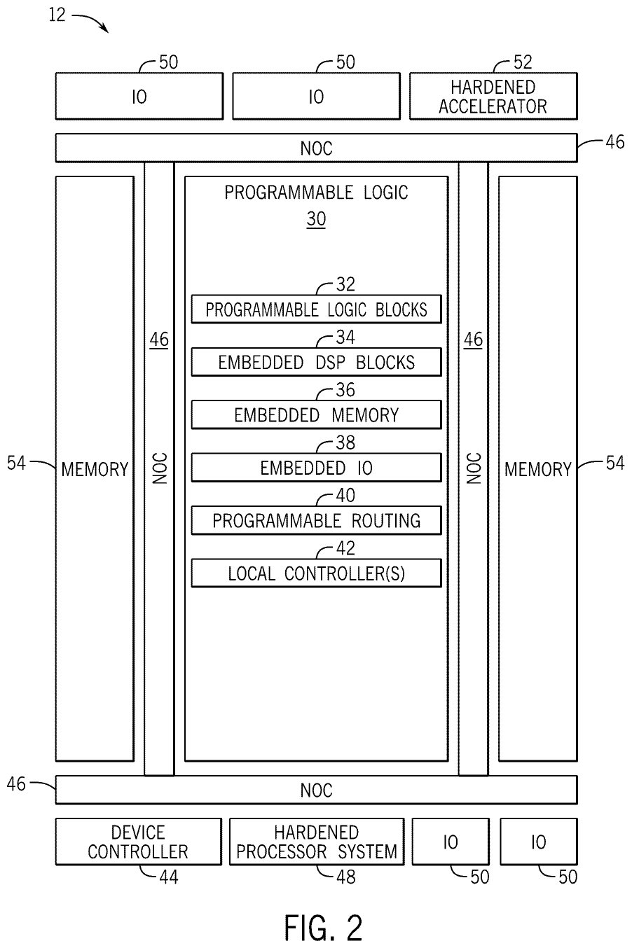

The host 20 may receive a host program 22 that may control or be implemented by a kernel program 24. To implement the host program 22, the host 20 may communicate instructions from the host program 22 to the integrated circuit system 12 via a communication link 26 that may include, for example, direct memory access (DMA) communications or peripheral component interconnect express (PCIe) communications. As will be described in greater detail below in FIG. 2, in some embodiments, the kernel program 24 and the host 20 may enable configuration of a logic block 28 on the integrated circuit system 12. The logic block 28 may include circuitry and/or other logic elements and may be configurable to implement a variety of functions in combination with digital signal processing (DSP) blocks.

The designer may use the design software 16 to generate and/or to specify a low-level program, such as the low-level hardware description languages described above. Further, in some embodiments, the system 10 may be implemented without the host program 22. Thus, embodiments described herein are intended to be illustrative and not limiting.

The integrated circuit system 12 may take any suitable form that may implement the data processing system 14. In one example shown in FIG. 2, the integrated circuit system 12 may include programmable logic circuitry 30, which may include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any of the programmable logic blocks 32 to implement any desired logic circuitry when configured with the system design configuration 14. The programmable logic blocks 32 and are sometimes referred to as logic array blocks (LABs) or configurable logic blocks (CLBs) that are used to build processing elements (PEs) that are arranged in an SA or an ACU. Each PE in the systolic array computes a partial result as a function of data from its upstream neighbors, stores the partial result, and passes it downstream to the next PE.

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38.

The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB, blocks of 4 MB, etc.). The embedded memory blocks 36 may be implemented using dual-port DRAM (DPRAM) or single-port DRAM (SPDRAM). Additionally or alternatively, the embedded memory blocks 36 may be implemented as SRAM.

The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40. The embedded IO blocks 38 may be programmable (along with the programmable routing 40) to enable appropriate communication for various different circuit designs including different routing, different voltages, different frequencies, and the like.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit system 12 may be controlled by programmable memory elements sometimes referred to as configuration random access memory (CRAM). Memory elements may be loaded with configuration data (also called programming data or a configuration bitstream) that represents the system design configuration 16. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit system 12. The device controller 44 may include any suitable logic circuitry to control and/or program the programmable logic circuitry 30 or other elements of the integrated circuit system 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit system 12.

A network-on-chip (NOC) 46 may connect the various elements of the integrated circuit system 12. The NOC 46 may provide rapid, packetized communication to and from the programmable logic circuitry 30 and other blocks, such as a hardened processor system 48, input/output (I/O) blocks 50, a hardened accelerator 52, and local device memory 54. The integrated circuit system 12 may include the hardened processor system 48 when the integrated circuit system 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit system 12. The I/O blocks 50 may enable communication using any suitable communication protocol(s) with other devices outside of the integrated circuit system 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

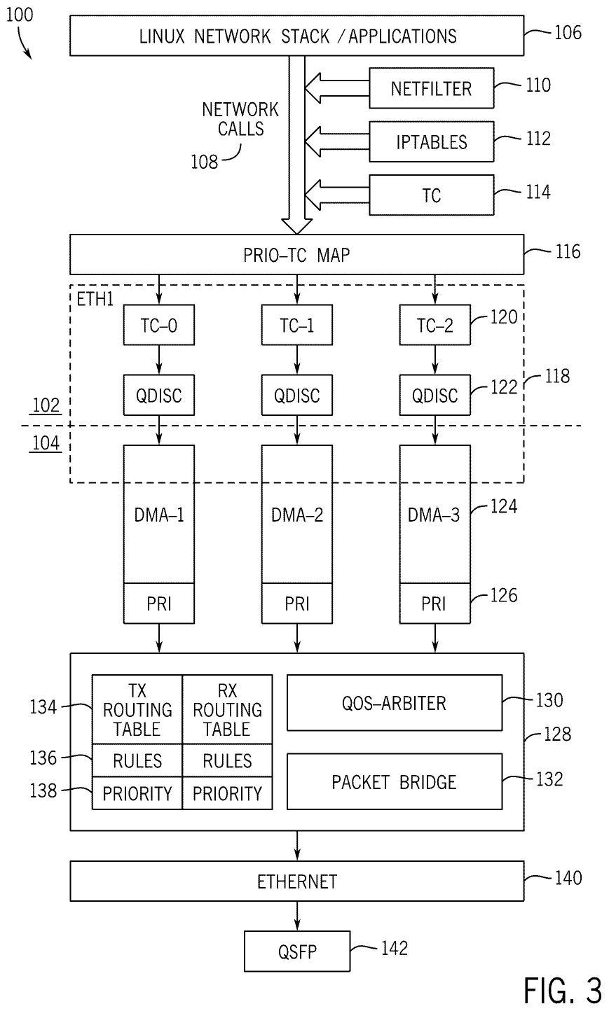

FIG. 3 is a block diagram of a system 100 that includes a host 102 that may send data over a hardware network device 104. The host 102 may be a processor (e.g., a CPU) executing software to perform the functions discussed below, and the hardware network device 104 may be part of and/or include a programmable logic device (e.g., FPGA).

The host 102 may implement one or more operating systems. For instance, in the illustrated embodiment, the host 102 may implement LINUX®, but additionally or alternatively, the host 102 may implement other operating systems. The host 102 includes network stack/applications 106 that send and receive data over a network connection as network calls 108. The host 102 also utilizes a netfilter 110 and/or any other software framework to enable network functionalities, such as packet filtering, network address translation (NAT), connection tracking, add kernel hooks as checkpoints for packets to perform packet logging, user-space packet queueing, and/or other core functionalities. In some implementations, the host 102 may utilize iptables 112 and/or another software framework/tool to specify/configure rules to be applied by the netfilter 110. The iptables 112 may include filter table(s), NAT table(s), mangle table(s) to change packet headers, raw table(s) that enable operations on packets before connection tracking starts, routing chains that define decision making in the packet processing flow, rules, targets indicating an action when a rule is matched, and the like.

The host 102 may also utilize traffic control (tc) 114 and/or another software framework/tool to configure and manage network traffic control settings for the OS kernel (e.g., Linux kernel). For instance, tc 114 may control a rate of transmission of outgoing traffic to manage bandwidth and/or smooth bursts, control the order of packet transmission to prioritize certain types of traffic, monitor and/or drop packets based on rate limits, classifying packets based on source/destination/ports/protocol.

The host 102 further uses a priority-traffic control (Prio-tc_ map 116 and/or another priority map that is used in traffic control to assign different levels of network priority to different types of network traffic. Specifically, the Prio-tc map 116 maps a type of service field of an IP packet to a numerical priority and determines which priority band the packet is placed into for queuing and transmission, enabling network administrators to prioritize latency-sensitive traffic (e.g., realtime interactive applications) over data that is less time-critical (e.g., bulk data transfers). The Prio-tc map 116 then steers the packets into a port 118 (e.g., Ethernet channel “eth 1”). On the host side, each port 118 includes a respective traffic class 120 (e.g., tc-0, tc-1, tc-2, etc.) and a queuing discipline (qdisc) 122.

The traffic class refers to the different traffic classes that are used to categorize and manage different types of network traffic to ensure QoS for applications, such as streaming data, voice calls, etc. For instance, tc-0 or traffic class zero may be a default traffic class that handles most data for applications. The traffic classes 120 use respective qdiscs 122 that act as a scheduler. The default scheduler may be first in first out (FIFO), but other qdiscs 122 may arrange packets entering the schedulers queue in accordance with scheduler rules.

Connected to each qdisc 122 is a DMA 124 (e.g., DMA-1, DMA-2, DMA-3, etc.) that is a DMA channel/engine. The DMAs 124 are used to transfer data between the host 102 and the hardware network device 104. For instance, each DMA 124 may include logic and/or hardware in the hardware network device 104 that implements DMA (e.g., remote DMA (RDMA)). Each DMA 124 may have its own associated priority 126.

Each DMA 124 connects to routing logic/circuitry 128 of the hardware network device 104. The routing logic/circuitry 128 may be implemented using a combination of hardware and programmable logic implemented in a programmable fabric. The routing logic/circuitry 128 includes a QOS arbiter 130. The QOS arbiter 130 may be implemented in hardware and/or software to manage and prioritize network or system resource requests to ensure QOS for different applications and/or users of the host 102. The QOS arbiter 130 may use algorithms like fixed priority or round-robin to grant access to shared resources, prevent congestion or starvation, and ensure fair use of shared resources. The QOS arbiter 130 may evaluate request priorities, monitor resource usage, and dynamically allocate resource usage based on defined QOS policies to ensure high-priority traffic receives timely and/or guaranteed access to bandwidth or processing resources.

The hardware networking device 104 further includes a packet bridge 132 that connects two or more network segments (e.g., connecting Ethernet 140 to the host 102 through the hardware networking device 104). The packet bridge 132 intelligently forwards data packets toward their destinations based on MAC addresses. To perform such forwarding, the packet bridge 132 may learn which devices are on which segments and improve network congestion and improve performance using the learned device locations.

To enable routing via the packet bridge 132 and QOS arbitration via the QOS arbiter 130, the routing logic/circuitry 128 includes routing tables 134. In the illustrated embodiment, there are separate routing tables for ingress (RX) packets and egress (TX) packets. In other embodiments, the routing tables 134 may be combined into a single table. The routing table(s) 134 are databases that store instructions for forwarding data packets toward their correct destination (e.g., via the proper network connections). In other words, the routing table(s) 134 act as maps using destination network addresses, subnet masks, next-hop addresses, and/or outgoing interfaces to determine the most efficient path for a packet's journey to its destination.

The routing logic/circuitry 128 may also include a rules table 136 to control how the QOS arbiter 130 arbitrates QOS. Likewise, the routing logic/circuitry 128 may further include a priority table 138 to control how packets are prioritized in the QOS arbiter 130.

From the routing logic/circuitry 128, data packets are transmitted over the Ethernet 140 (or another network connection) to and from a transceiver. For instance, the illustrated transceiver is a quad small form-factor pluggable (QSFP) 142 transceiver.

As may be appreciated, the hardware networking device 104 provides QOS functionality using multiple hardware queues in DMAs 124. As previously noted, in conventional network switches, the number of queues associated with the hardware network port cannot be changed dynamically. Even if the hardware supports increasing the number of queues, it is still limited to what the hardware actually supports. For example, if the network switch provides 2 DMA queues per network port, the network service provider cannot change that configuration and has to build the network around that limitation. The service provider may provide software-based implementations of QOS handling, but that functionality would be limited to the software stack, and the design would not provide full stack QOS functionality. As described below using programmable logic devices, customers and/or service providers can configure and adapt the number of DMAs associated with a network port to provide the best usability scenario for the customer. Thus, the service provider can create new DMA queues to an existing network port and dynamically associate a data flow to it to create both receive side scaling and/or transmit side scaling.

In a generic system that provides QOS functionality, the hardware provides multiple queues and the software supports traffic classification as noted above. At the software level, the traffic class provides the packet flow and classification. Each of these packet flows can be mapped to different queues. The data packets are then copied over to the hardware using DMAs 124. The hardware then processes the data packets on priority basis to send them out of the system. The hardware copies the data over from the DRAM (e.g., embedded memory blocks 36) using DMA. If a single DMA engine is used, it can lead to head of line blocking where low-priority packets block high-priority packets. If multiple DMAs are used this can be at least partially mitigated. However, the number of DMAs and the number of queues that the HW supports are fixed requiring an underutilization resources or potential head of line blocking.

Programmable logic devices enable an architecture where the number of DMAs that are associated with the network port can be dynamically changed. As discussed below, DMA subsystems may be statically instantiated in the FPGA design or dynamically created through programming partial reconfiguration (PR) regions. Once a DMA is dynamically instantiated in a PR region, it can be associated with any of the network ports provided by the ethernet subsystem.

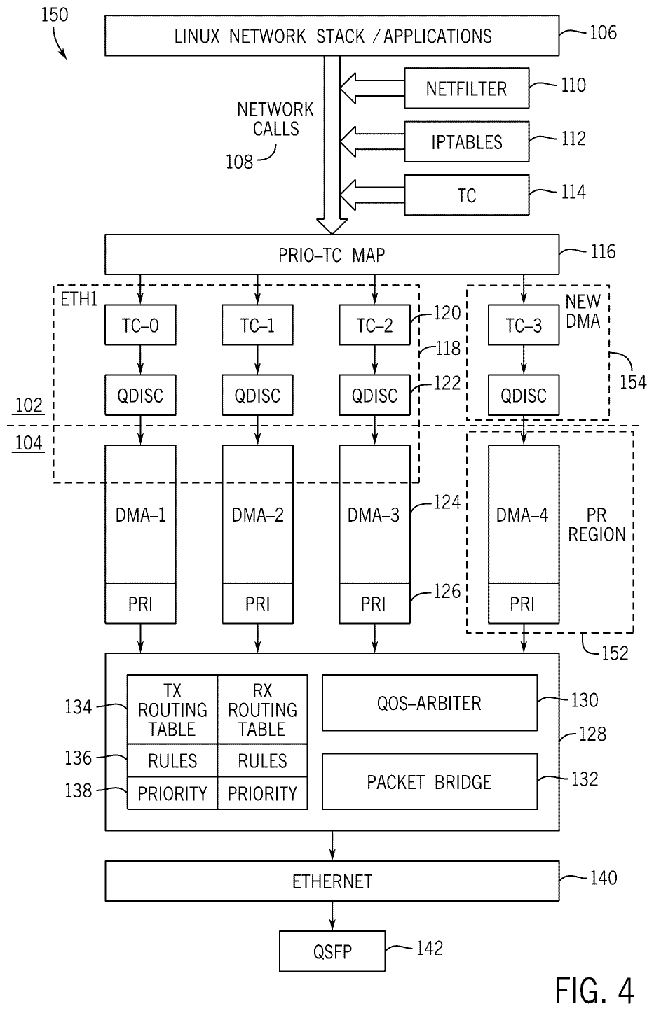

FIG. 4 shows a system 150 that is similar to the system 100 of FIG. 3 except that a new DMA has been added in a PR region 152 in addition to the 3 DMAs assigned to the Ethernet port 118. Once instantiated in the PR region 152, the new DMA subsystem is connected to the QOS arbiter 130.

The new DMA in the PR region 152 can then be used to send and receive packets between the host 102 and the hardware networking device 104. The QOS arbiter 130 can be programmed to route packets according to new rules to route packets to the new DMA from the Ethernet port and/or external interface. The rules in rules table(s) 136 can be run by the QOS arbiter 130 in a priority-based fashion indicated in the priority table(s) 138. If one of the DMA queue is full and back pressures the QOS arbiter 130 in the receive direction, then the QOS arbiter 130 can still send other higher priority packets to other DMAs to be consumed by other CPUs.

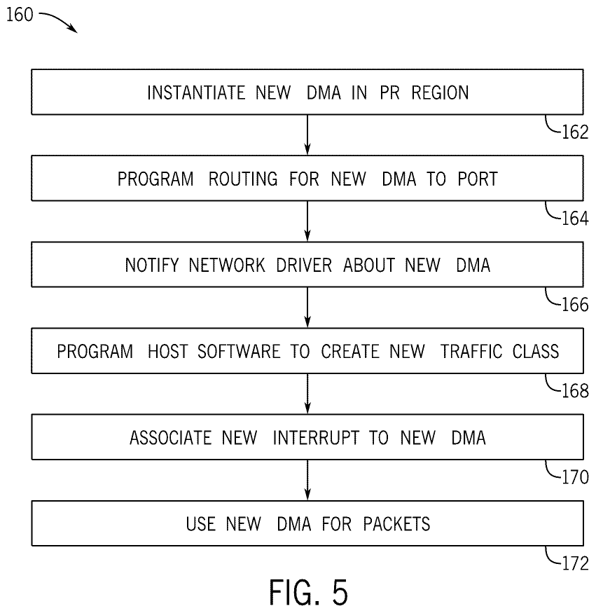

FIG. 5 is a block diagram of the process 160 for establishing and using the new DMA in the PR region 152. The process 160 begins with instantiation of a new DMA in the PR region 152 via a PR of the programmable fabric of the hardware networking device 104 (block 162). This instantiation may be in response to receiving a command from a user or service provider to add a new DMA. Additionally or alternatively, the new DMA may be added by a script either invoked by a user or service provider or in response to certain conditions. For instance, if a key performance indicator (KPI) indicates a failure such as that bandwidth is available, bandwidth is limited, packets have been dropped, packet blocking is occurring, and/or any other KPIs, the host 102, the FPGA of the hardware networking device 104, and/or any other systems may invoke the instantiation using intelligent algorithms implemented on the host, the FPGA, and/or any external systems. For example, the host 102 may send a request to add a new DMA to the hardware networking device 104 to cause the hardware networking device to add the new DMA. The instantiation may be performed using a PR that keeps the FGPA online during the PR and reconfigures just a portion of the FPGA. These DMA implementations via PR may be compiled in the compiler 18 and stored in configuration RAM (CRAM) prior to runtime and implemented during runtime by loading the stored configuration from CRAM into the programmable fabric as the new DMA in the PR region 152.

The host 102 and/or the hardware networking device 104, based on user instructions, a script, and/or the like, then programs the routing logic/circuitry 128 for the new DMA port (block 164). For instance, programming may include programming the packet bridge 132 to route packets from the new DMA to the Ethernet port 140 in the transmission direction by programming the TX routing table 134. Programming may also include associating a priority with the DMA port so that egress QOS may be provided via the QOS arbiter 130. In addition to programming egressing/transmission direction, the host 102 and/or the hardware networking device 104, based on user instructions, a script, and/or the like, program an ingress QOS rule in the rules table(s) 136 to support data flows to send packets from the port 118 to the new DMA.

Once the routing is programmed, the host 102 and/or the hardware networking device 104 notify the network (e.g., Ethernet) driver about the new assignment of the DMA (block 166). For example, the hardware networking device 104 may notify the driver via PCIe from an FPGA. The host 102 and/or the hardware networking device 104 may associate a priority for the new DMA for the driver. The driver can then add the new DMA to its transmitter and receiver paths.

The host 102 and/or the hardware networking device 104, based on user instructions, a script, and/or the like, program host software to create a new traffic class (block 168). Programming the host software to create the new traffic class may include creating and storing any rules used to do egress QOS processing.

The host 102 and/or the hardware networking device 104, based on user instructions, a script, and/or the like, allocates and associates a new interrupt to the new DMA to start transmitter and/or receiver processing (block 170). After association is completed, all packets destined for the new traffic class software queue are routed to the new DMA. The new DMA picks data from the queue with respect to its priority and prepares to send data to port 118. The QOS arbiter 130 arbitrates among the total number (e.g., 4) of DMA ports including the new DMA port. In this arbitration, the QOS arbiter 130 gets packets from the DMAs and sends them over the Ethernet 140 for transmission.

Thus, after such association, the hardware networking device 104 uses the new DMA for packets (block 172). When an RX packet is received on the port 118, the packet bridge 132 uses the rules to find where the data is destined. Data destined for the new DMA is transferred to DRAM, and the new DMA raises an interrupt for the respective CPU to consume the packet based on priority.

The following Table 1 includes an example system with one Ethernet port have a single DMA that is shared between two user flows from different users and/or different applications. Due to the shared resources, there is contention and shared bandwidth between the user flows.

TABLE 1
Example User Flow with 1 DMA

| | | | |
|---|---|---|---|
| Interval (s) | Transfer | Bitrate | CWND |

User flow-1

| | | | |
|---|---|---|---|
| 0.00-1.00 | 53.5 | 448 | 21.2 |
| | MBs | Mb/s | KBs |
| 1.00-2.00 | 52.8 | 442 | 21.2 |
| | MBs | Mb/s | KBs |
| 2.00-3.00 | 52.4 | 440 | 21.2 |
| | MBs | Mb/s | KBs |

User flow-2

| | | | |
|---|---|---|---|
| 0.00-1.00 | 54 | 453 | 21.2 |
| | MBs | Mb/s | KBs |
| 1.00-2.00 | 53.5 | 449 | 21.2 |
| | MBs | Mb/s | KBs |
| 2.00-3.00 | 53.1 | 446 | 21.2 |
| | MBs | Mb/s | KBs |

As illustrated in Table 1, both user flows are services by the same DMA and contend for resources. Since the DMA buffering/link is limited (e.g., 1 GBps), the user flows are both managed equally. But if User flow-1 has a higher priority, providing it with a single instance of a DMA for itself with higher priority will help produce better results in packet flow management. After an additional DMA is added (e.g., via a PR region), Table 2 may show the resultant user flows with a dynamically added new DMA with higher priority.

TABLE 2
Example User Flow with High-Priority DMA

| | | | |
|---|---|---|---|
| Interval (s) | Transfer | Bitrate | CWND |

User flow-1

| | | | |
|---|---|---|---|
| 0.00-1.00 | 82.1 | 688 | 49.5 |
| | MBs | Mb/s | KBs |
| 1.00-2.00 | 80.9 | 678 | 49.5 |
| | MBs | Mb/s | KBs |
| 2.00-3.00 | 81.5 | 684 | 49.5 |
| | MBs | Mb/s | KBs |

User flow-2

| | | | |
|---|---|---|---|
| 0.00-1.00 | 25.1 | 211 | 21.2 |
| | MBs | Mb/s | KBs |
| 1.00-2.00 | 25.8 | 216 | 21.2 |
| | MBs | Mb/s | KBs |
| 2.00-3.00 | 25.6 | 215 | 21.2 |
| | MBs | Mb/s | KBs |

In Table 2, User flow-1 receives preferential treatment from the new DMA and the underlying Ethernet because it is associated with higher priority. User flow-2 receives some bandwidth because of the fact that the arbitration is not hard priority-based and multiple CPUs can be used to pump data. In a system that supports hard priority-based scheduling and packets processing, the new DMA would receive only leftover bandwidth after the original DMA has exhausted its bandwidth. Since the DMAs may be programmed on the fly using programmable regions, the base FPGA design may remain the same.

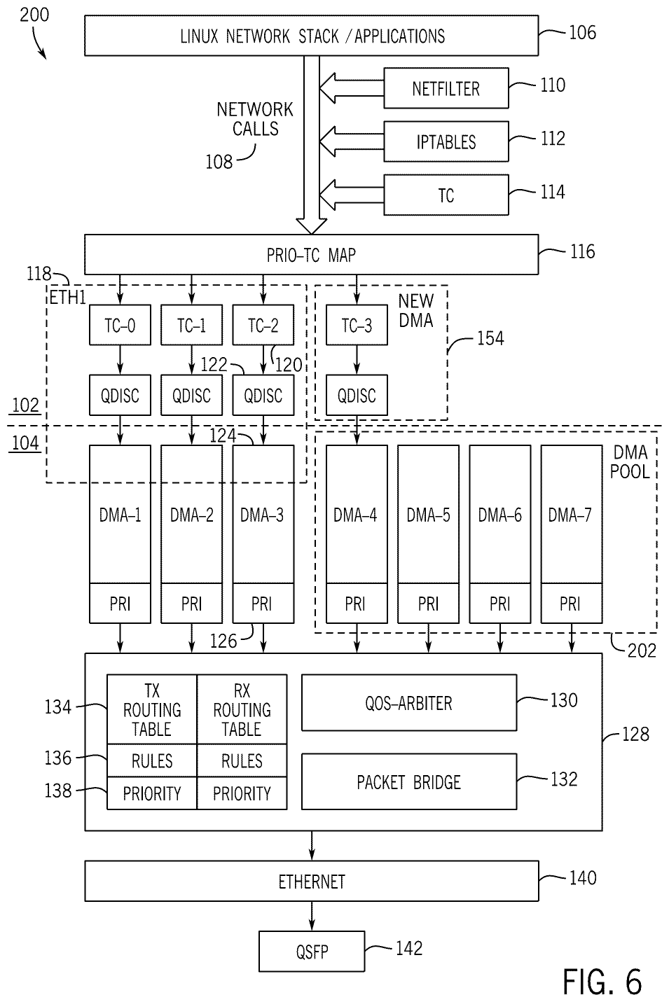

Some service providers and/or customers may prefer to avoid PR regions since such regions may consume more power and/or size than programmable logic devices that do not include PR regions. Thus, an alternative may be useful in such situations. As previously noted, DMAs may be dynamically associated to the port 118 during runtime using a pool of unassociated DMAs (in addition to or in place of PR region-based dynamic DMA association). FIG. 6 shows a block diagram of a system 200 that is similar to the system 150 except that the new DMA is added via a DMA pool 202 of unassociated DMAs that may be dynamically associated with different ports, such as the port 118. This DMA pool 202 may be dedicated to one customer or may be available to and/or divided between multiple tenants based on the assignment of the DMAs.

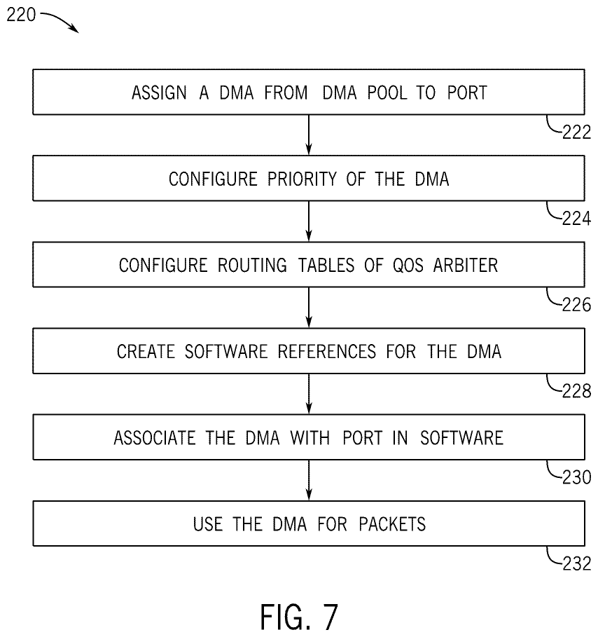

FIG. 7 is a flow diagram of a process 220 for associating a DMA from the DMA pool 202 to the port 118. The host 102 and/or the hardware networking device 104 assigns at least one of the unassociated DMAs from the DMA pool 202 to the port 118 (block 222). The host and/or the hardware networking device 104 then configures a priority of the DMA (block 224). For instance, the priority may be based on a priority of the data flow to occur through the DMA.

The host and/or the hardware networking device 104 also configure routing tables of the QOS arbiter 130 (block 226). For instance, the host and/or the hardware networking device 104 may configure the TX routing table 134 and the RX routing table 134 of the QOS arbiter 130. The TX routing table 134 contains the priority of the data flow to the Ethernet port 140 from which the data exits. The RX routing table 134 contains the priority and the rules that are used to pass the data to be routed from the Ethernet port 140 to the DMA.

The host and/or the hardware networking device 104 also creates software references for the new DMA (block 228). For instance, the host and/or the hardware networking device 104 creates DMA rings and/or the associate interrupt for the DMA.

The host 102 and/or the hardware networking device 104, based on user instructions, a script, and/or the like, allocates and associates the new interrupt to the new DMA to start transmitter and/or receiver processing (block 230). After association is completed, all packets destined for the new traffic class software queue are routed to the new DMA. The new DMA picks data from the queue with respect to its priority and prepares to send data to port 118. The QOS arbiter 130 arbitrates among the total number (e.g., 4) of DMA ports including the new DMA port. In this arbitration, the QOS arbiter 130 gets packets from the DMAs and sends them over the Ethernet 140 for transmission.

Thus, after such association, the hardware networking device 104 uses the new DMA for packets (block 232). When an RX packet is received on the port 118, the packet bridge 132 uses the rules to find where the data is destined. Data destined for the new DMA is transferred to DRAM, and the new DMA raises an interrupt for the respective CPU to consume the packet based on priority.

With the DMA pool protocol, the new DMA can be associated with the existing port 118. Since the number of DMAs to the port 118 has increased, the data flows on the port 118 will have enhanced bandwidth and/or QOS capabilities. Furthermore, similar allocation may be applied when a DMA is to be moved from one port to another that demands higher bandwidth and/or QOS capabilities. Using the DMA pool or PR region-based dynamic DMA allocation, DMAs may be allocated during runtime without impacting other ports and/or causing system downtime to shutdown the programmable logic device.

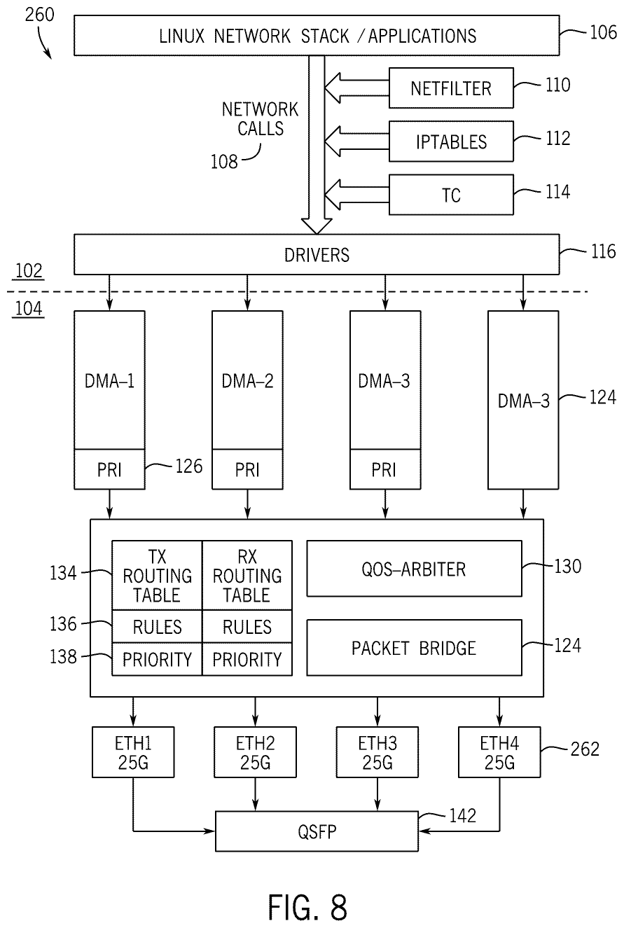

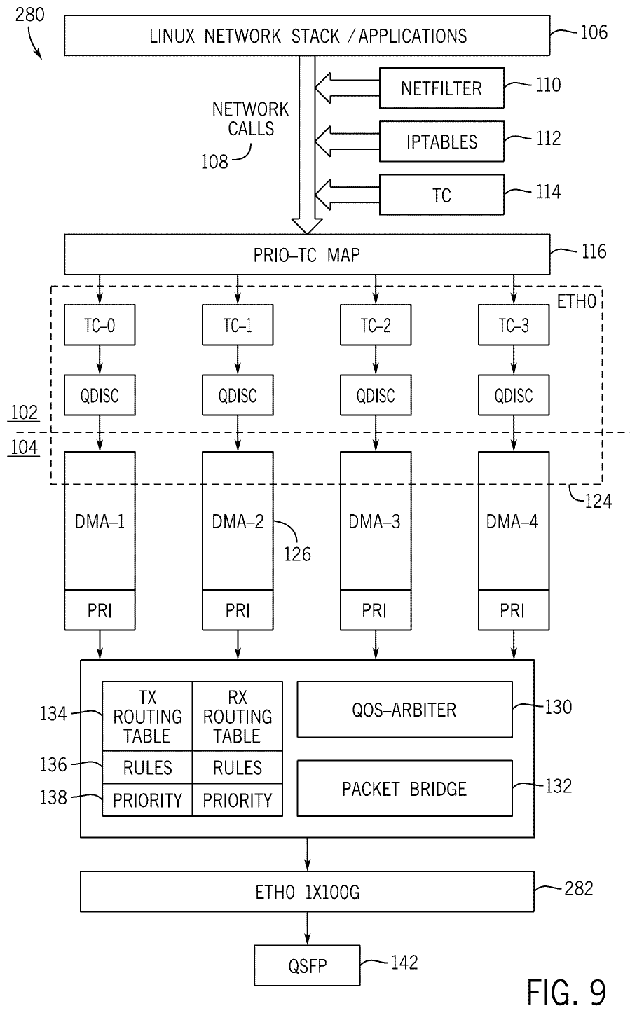

When break-out ports are part of the allocation for DMAs, the ports may be broken out dynamically to ensure that certain QOS features can be provided for important ports. For example, in FIG. 8, a system 260 is similar to the system 150 of above except that the system 260 includes a 4×25 GB port 262. The system 260 enables the service provider to assign one DMA to each port. However, the service provider and/or a user may desire to aggregate the 4×25 GB port 262 into a single port. FIG. 9 is a block diagram of a system 280 that includes a single 1×100 GB port 282. The customer and/or service provider may assign all DMAs to the same port 282 to provide QOS features to the port.

Dynamic DMA assignment may further be useful in network testing equipment that tests NIC cards that support QOS functionality. With multiple NIC card types providing different number of HW queues, the customer will have to configure the test equipment to handle the traffic from multiple queues. But if the test equipment does not provide that as many queues as are to be tested, the user flow testing with respect to full stack QOS handling cannot be fully tested. With dynamic DMA allocation discussed previously, the test equipment can be dynamically configured without much effort to handle multiple queues according to what is supported by the test card. In such a way, the user flows from the NIC card can be prioritized and handled in the programmable logic design, thereby testing full stack QOS implementations. For example if a NIC card supports 4 queues, the testing equipment can be configured to have 4 DMAs dynamically to map to the 4 queues and the system can be configured to do priority-based packet processing on the stream based on the user flow parameters. Since the test equipment can mimic the test NIC capabilities exactly, packet processing and priority based classification protocols can be tested seamlessly.

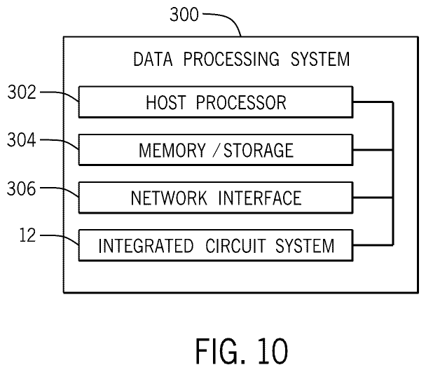

The processes discussed above may be carried out on the integrated circuit system 12, which may be a component included in a data processing system, such as a data processing system 300, shown in FIG. 10. The data processing system 300 may include the integrated circuit system 12 (e.g., a programmable logic device), a host processor 302, memory and/or storage circuitry 304, and a network interface 306. The data processing system 300 may include more or fewer components (e.g., electronic display, user interface structures, application specific integrated circuits (ASICs)). The host processor 302 may include any of the foregoing processors that may manage a data processing request for the data processing system 300 (e.g., to perform elaboration and simulation, to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 304 may include random access memory (RAM), read-only memory (ROM), one or more hard drives, flash memory, or the like. The memory and/or storage circuitry 304 may hold data to be processed by the data processing system 300. In some cases, the memory and/or storage circuitry 304 may also store configuration programs (e.g., bitstreams, mapping function) for programming the integrated circuit system 12. The network interface 306 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. In another example, components of the data processing system 300 may be located in separate geographic locations or areas, such as cities, states, or countries.

The data processing system 300 may be part of a data center that processes a variety of different requests. For example, the data processing system 300 may receive a data processing request via the network interface 306 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

### Example Embodiment 1

An integrated circuit system, comprising:
a host comprising a plurality of Ethernet channels; and
a programmable logic device comprising a programmable logic fabric coupled to the plurality of Ethernet channels, wherein the programmable logic device is configured to:
   dynamically associate a direct memory access (DMA) engine of the programmable logic fabric to an Ethernet channel of the plurality of Ethernet channels during runtime of the programmable logic device without bringing the programmable logic device or other Ethernet channels down;
   store routing information configuration details in tables of a quality of service (QOS) arbiter; and
   provide QOS services, via the QOS arbiter of the programmable logic device, for packets that use the dynamically associated DMA engine.

### Example Embodiment 2

The integrated circuit system of example embodiment 1, wherein dynamically associating the DMA engine of the programmable logic fabric to the Ethernet channel comprises instantiating the DMA engine in a partial reconfiguration (PR) region of the programmable logic fabric during runtime of the programmable logic device.

### Example Embodiment 3

The integrated circuit system of example embodiment 1, wherein the DMA engine is one of a plurality of DMA engines in the programmable logic fabric.

### Example Embodiment 4

The integrated circuit system of example embodiment 3, wherein the plurality of DMA engines comprises a DMA pool of DMA engines that are available for assignment to the plurality of Ethernet channels.

### Example Embodiment 5

The integrated circuit system of example embodiment 4, wherein the DMA pool of DMA engines are shared between different processors or tenants of the programmable logic device.

### Example Embodiment 6

The integrated circuit system of example embodiment 1, wherein storing routing information comprises programming a packet bridge of the programmable logic device to route packets from the DMA engine to an Ethernet port.

### Example Embodiment 7

The integrated circuit system of example embodiment 1, wherein storing routing information comprises associating a priority with the DMA engine for egress through the QOS arbiter.

### Example Embodiment 8

The integrated circuit system of example embodiment 1, wherein storing routing information comprises programming a QOS rule in a rules table of the QOS arbiter to support data flows to send packets through the DMA.

### Example Embodiment 9

An integrated circuit system, comprising:
a host comprising a plurality of Ethernet channels; and
a programmable logic device comprising a programmable logic fabric coupled to the plurality of Ethernet channels, wherein the programmable logic device is configured to instantiate a new direct memory access (DMA) engine for the host, wherein the host or programmable logic device are to:
   program routing for the new DMA engine to a port;
   notify a network driver about the new DMA engine;
   program host software to create a new traffic class;
   associate a new interrupt to the new DMA engine; and
   use the new DMA engine for packets using the new traffic class and new interrupt.

### Example Embodiment 10

The integrated circuit system of example embodiment 9, wherein instantiation of the new DMA engine comprises instantiating the new DMA engine in a partial reconfiguration (PR) region of the programmable logic fabric.

### Example Embodiment 11

The integrated circuit system of example embodiment 9, wherein the host is configured to receive a command from a user or service provider to add the new DMA engine, and the instantiation is in response to receiving the command.

### Example Embodiment 12

The integrated circuit system of example embodiment 9, wherein programming routing comprises:
programming a transmitter (TX) routing table to cause a packet bridge to route packets from the new DMA engine to an Ethernet port in a transmitter direction;
   programming a receiver (RX) routing table in a receiver direction; and
   programming quality of service (QOS) rules and priority for a QOS arbiter of the programmable logic fabric.

### Example Embodiment 13

The integrated circuit system of example embodiment 9, wherein notifying the network driver comprises notifying an Ethernet driver.

### Example Embodiment 14

The integrated circuit system of example embodiment 9, wherein programming host software comprises programming an operating system of the host to create and store rules used to perform egress quality of service (QOS) processing.

### Example Embodiment 15

An integrated circuit system, comprising:
a host comprising a plurality of Ethernet channels; and
a programmable logic device comprising a programmable logic fabric coupled to the plurality of Ethernet channels, wherein the programmable logic device is comprises a pool of direct memory access (DMA) engines available to be used by the host, wherein the host or programmable logic device are to:
   assign a DMA engine from the pool of DMA engines; configure a priority of the DMA engine;
   configure routing tables of a quality of service (QOS) arbiter of the programmable logic device;
   create software references for the DMA engine;
   associate the DMA with a port in software; and
   use the DMA for packet transmission.

### Example Embodiment 16

The integrated circuit system of example embodiment 15, wherein the pool of DMA engines comprises a plurality DMA engines that are unassociated with the plurality of Ethernet channels.

### Example Embodiment 17

The integrated circuit system of example embodiment 15, wherein the pool of DMA engines are available for different tenants of the programmable logic device.

### Example Embodiment 18

The integrated circuit system of example embodiment 15, wherein the pool of DMA engines are available for different processors of the integrated circuit system.

### Example Embodiment 19

The integrated circuit system of example embodiment 15, wherein the priority is based at least in part on a priority of a data flow to occur through the DMA engine.

### Example Embodiment 20

The integrated circuit system of example embodiment 15, wherein configuring the routing comprises:
configuring a transmitter (TX) routing table to contain priority of data from the DMA engine to an Ethernet port, and
configuring a receiver (RX) routing table to contain priority of data from the DMA engine to the Ethernet port.

What is claimed is:

1. An integrated circuit system, comprising:
a host comprising a plurality of Ethernet channels; and
a programmable logic device comprising a programmable logic fabric coupled to the plurality of Ethernet channels, wherein the programmable logic device is configured to:
dynamically associate a direct memory access (DMA) engine of the programmable logic fabric to an Ethernet channel of the plurality of Ethernet channels during runtime of the programmable logic device without bringing the programmable logic device or other Ethernet channels down;
store routing information configuration details in tables of a quality of service (QOS) arbiter; and
provide QOS services, via the QOS arbiter of the programmable logic device, for packets that use the dynamically associated DMA engine.

2. The integrated circuit system of claim 1, wherein dynamically associating the DMA engine of the programmable logic fabric to the Ethernet channel comprises instantiating the DMA engine in a partial reconfiguration (PR) region of the programmable logic fabric during runtime of the programmable logic device.

3. The integrated circuit system of claim 1, wherein the DMA engine is one of a plurality of DMA engines in the programmable logic fabric.

4. The integrated circuit system of claim 3, wherein the plurality of DMA engines comprises a DMA pool of DMA engines that are available for assignment to the plurality of Ethernet channels.

5. The integrated circuit system of claim 4, wherein the DMA pool of DMA engines are shared between different processors or tenants of the programmable logic device.

6. The integrated circuit system of claim 1, wherein storing routing information comprises programming a packet bridge of the programmable logic device to route packets from the DMA engine to an Ethernet port.

7. The integrated circuit system of claim 1, wherein storing routing information comprises associating a priority with the DMA engine for egress through the QOS arbiter.

8. The integrated circuit system of claim 1, wherein storing routing information comprises programming a QOS rule in a rules table of the QOS arbiter to support data flows to send packets through the DMA.

9. An integrated circuit system, comprising:
a host comprising a plurality of Ethernet channels; and
a programmable logic device comprising a programmable logic fabric coupled to the plurality of Ethernet channels, wherein the programmable logic device is configured to instantiate a new direct memory access (DMA) engine for the host, wherein the host or programmable logic device are to:
program routing for the new DMA engine to a port;
notify a network driver about the new DMA engine;
program host software to create a new traffic class;
associate a new interrupt to the new DMA engine; and
use the new DMA engine for packets using the new traffic class and new interrupt.

10. The integrated circuit system of claim 9, wherein instantiation of the new DMA engine comprises instantiating the new DMA engine in a partial reconfiguration (PR) region of the programmable logic fabric.

11. The integrated circuit system of claim 9, wherein the host is configured to receive a command from a user or service provider to add the new DMA engine, and the instantiation is in response to receiving the command.

12. The integrated circuit system of claim 9, wherein programming routing comprises:
programming a transmitter (TX) routing table to cause a packet bridge to route packets from the new DMA engine to an Ethernet port in a transmitter direction;
programming a receiver (RX) routing table in a receiver direction; and
programming quality of service (QOS) rules and priority for a QOS arbiter of the programmable logic fabric.

13. The integrated circuit system of claim 9, wherein notifying the network driver comprises notifying an Ethernet driver.

14. The integrated circuit system of claim 9, wherein programming host software comprises programming an operating system of the host to create and store rules used to perform egress quality of service (QOS) processing.

15. An integrated circuit system, comprising:
a host comprising a plurality of Ethernet channels; and
a programmable logic device comprising a programmable logic fabric coupled to the plurality of Ethernet channels, wherein the programmable logic device is comprises a pool of direct memory access (DMA) engines available to be used by the host, wherein the host or programmable logic device are to:
assign a DMA engine from the pool of DMA engines;
configure a priority of the DMA engine;
configure routing tables of a quality of service (QOS) arbiter of the programmable logic device;
create software references for the DMA engine;
associate the DMA with a port in software; and
use the DMA for packet transmission.

16. The integrated circuit system of claim 15, wherein the pool of DMA engines comprises a plurality DMA engines that are unassociated with the plurality of Ethernet channels.

17. The integrated circuit system of claim 15, wherein the pool of DMA engines are available for different tenants of the programmable logic device.

18. The integrated circuit system of claim 15, wherein the pool of DMA engines are available for different processors of the integrated circuit system.

19. The integrated circuit system of claim 15, wherein the priority is based at least in part on a priority of a data flow to occur through the DMA engine.

20. The integrated circuit system of claim 15, wherein configuring the routing comprises:
configuring a transmitter (TX) routing table to contain priority of data from the DMA engine to an Ethernet port, and
configuring a receiver (RX) routing table to contain priority of data from the DMA engine to the Ethernet port.
